(19) United States
(12) Patent Application Publication
(10) Pub. No.: US 2008/0098423 A1
(43) Pub. Date: Apr. 24, 2008

(54) Methods, Systems, And Computer Program Products For Selecting And Inserting Advertising Into Slots In Broadcast Content

(75) Inventor: Dale Malik, Atlanta, GA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/551,428

(22) Filed: Oct. 20, 2006

(51) Int. Cl. H04N 7/025; G06F 13/00; H04N 7/10; G06F 3/00; H04N 5/445

(52) U.S. Cl. 725/34; 725/35; 725/46

(57) ABSTRACT

Methods, systems, and computer program products that facilitate selecting advertisements for insertion into advertisement slots in broadcast content are provided. Broadcast criteria for the content and viewer criteria are identified. Broadcast criteria includes information about the content and viewer criteria includes information about viewers to whom the content is targeted. Information is retrieved from a plurality of tags attached to a respective plurality of stored advertisements that are available for insertion into the advertising slot. Each tag includes information about a respective advertisement. An advertisement having tag information that is compatible with identified broadcast criteria and viewer criteria is selected and inserted into the advertising slot. Various information about the selected advertisement, what criteria was used to select the advertisement, etc., may be recorded via a log file.

### FIELD OF THE INVENTION

The present invention relates generally to advertising and, more particularly, to methods, apparatus, and computer program products for selecting and placing advertising.

### BACKGROUND OF THE INVENTION

Consumers may not be receptive to advertising (e.g., broadcast advertising received via television, advertising transmitted via the web, etc.) for products/services that are of little interest or that have little or no entertainment value. For example, some consumers may not care to view advertising related to automobile or beer sales. Some consumers may be receptive to any advertising that is somewhat entertaining, etc.

In advertising, it is considered highly desirable to target advertisements and other promotional efforts to specific consumers (often referred to as “direct marketing”), rather than to broadcast advertisements to consumers in general. By targeting advertising to individual consumers, the likelihood may be increased that a consumer will read and act upon the advertising. Successful direct marketing campaigns typically require specific information about consumers that are being targeted. Unfortunately, obtaining information sufficient to conduct effective direct marketing campaigns via television and the web may be difficult.

### SUMMARY OF THE INVENTION

Embodiments of the present invention provide methods, systems, and computer program products that facilitate selecting advertisements for insertion into advertisement slots in broadcast content, such as television programming, radio programming, programming broadcast via a computer network, etc. According to some embodiments of the present invention, a method of inserting an advertisement into an advertising slot within content broadcast to viewers, includes identifying broadcast criteria for the content and viewer criteria, wherein broadcast criteria comprises information about the content and wherein viewer criteria comprises information about viewers to whom the content is targeted, and retrieving information from a plurality of tags attached to a respective plurality of stored advertisements that are available for insertion into the advertising slot. Each tag includes information about a respective advertisement. An advertisement having tag information that is compatible with identified broadcast criteria and viewer criteria is selected and inserted into the advertising slot. Various information about the selected advertisement, what criteria was used to select the advertisement, etc., may be recorded via a log file.

Broadcast criteria may include time of day information that content is to be broadcast to viewers and/or information about types of viewers to whom the broadcast content is targeted. Viewer criteria may include viewer preference information regarding broadcast content, viewer preference information regarding advertisements, viewer personal characteristics, and/or viewer demographic information. Tag information includes information regarding advertisement type and category, targeted viewers, advertisement rating, advertisement duration and repetition, advertisement style, and/or advertisement interactivity.

Other methods, apparatus and/or computer program products according to embodiments of the invention will be or become apparent to one with skill in the art upon review of the following drawings and detailed description. It is intended that all such additional methods, apparatus, and/or computer program products be included within this description, be within the scope of the present invention, and be protected by the accompanying claims.

### BRIEF DESCRIPTION OF THE DRAWINGS

The accompanying drawings, which form a part of the specification, illustrate key embodiments of the present invention. The drawings and description together serve to fully explain the invention.

FIG. 1 is a block diagram that illustrates a tag attached to respective advertisement, according to some embodiments of the present invention.

FIG. 2 is a block diagram that illustrates exemplary information contained within the tag of FIG. 1.

FIG. 3 is a block diagram that illustrates a decision engine for selecting advertisements for insertion into advertising slots in broadcast content, according to some embodiments of the present invention.

FIGS. 4-5 are flow charts that illustrate exemplary operations for selecting advertisements for insertion into advertising slots in broadcast content, according to some embodiments of the present invention.

FIG. 6 is a block diagram that illustrates a processor and a memory hosted by a device that serves the function of a decision engine and that may be used in embodiments of methods, systems, and computer program products for selecting advertisements for insertion into advertising slots in broadcast content, such as television programming, according to some embodiments of the present invention.

### DETAILED DESCRIPTION OF EMBODIMENTS OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Java, AJAX (Asynchronous JavaScript), C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. Embodiments of the present invention are not limited to a particular programming language. It will be further appreciated that the functionality of any or all of the program modules may also be implemented using discrete hardware components, one or more application specific integrated circuits (ASICs), or a programmed digital signal processor or microcontroller.

The present invention is described herein with reference to flowchart and/or block diagram illustrations of methods, systems, and computer program products in accordance with exemplary embodiments of the invention. These flowchart and/or block diagrams further illustrate exemplary operations for selecting advertisements for insertion into advertising slots in broadcast content, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

As used herein, the term “advertisement” is intended to mean any type of advertisement delivered in any type of media broadcast to viewers. For example, an advertisement may be in the form of an audio file, a video file, and audio-video file, a text file, etc., that can be delivered and/or performed/displayed via a device. For example, an advertisement may be delivered via radio, television, computer (e.g., via the internet or other network). An advertisement may be inserted in slots located in various portions of a radio program, a television program, a movie, on a web page, etc.

As used herein, the terms “content” and “broadcast content” are interchangeable and are intended to mean any type of content broadcast to viewers. For example, broadcast content may include television programs, radio programs, movies, voice messages, music and other audio files, electronic mail/messages, web pages, etc. Any type of broadcast content having a slot that an advertisement can be inserted into may be considered content, according to embodiments of the present invention. Although embodiments of the present invention described herein are directed to broadcast television program content and advertising inserted therein, it is understood that other types of content and advertising directed to those other types of content are intended to be included within embodiments of the present invention.

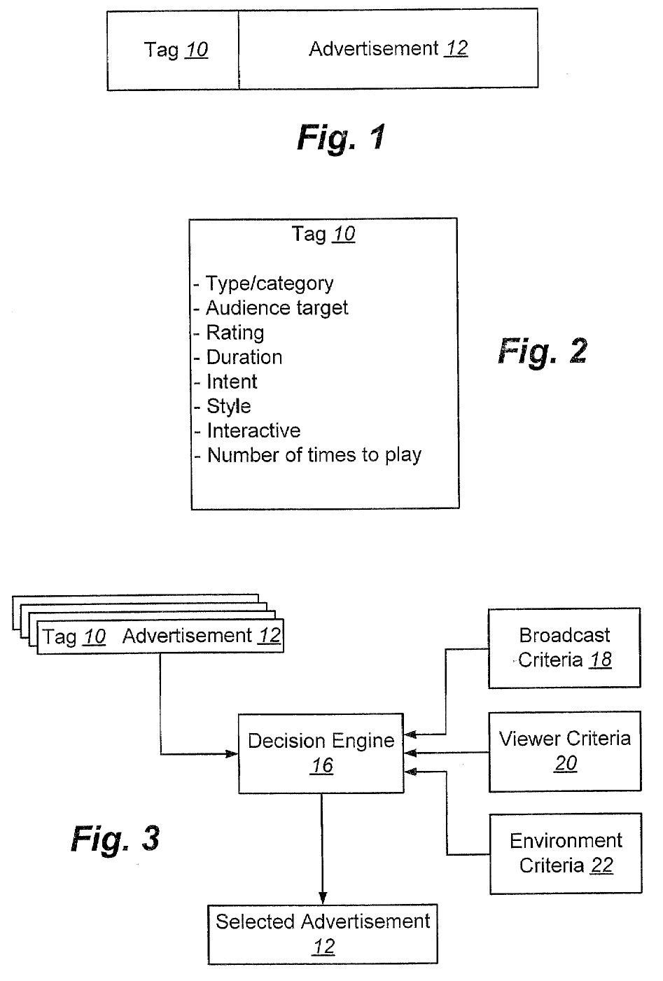

FIG. 1 is a block diagram that illustrates a tag 10 attached to an advertisement, according to some embodiments of the present invention. The tag 10 may be any type of tag that can be attached to a file such as, for example an XML (Extensible Markup Language) tag or an HTML (Hypertext Markup Language) meta tag. XML tags and HTML meta tags are well known to those skilled in the art and need not be described herein.

Stored within the tag 10 can be various types of information about the advertisement 12 to which the tag is attached. For example, as illustrated in FIG. 2, the tag 10 may include information about the type and category of the advertisement 12. Advertisement type/category may include, but is not limited to, whether the advertisement relates to a new product or an existing product, whether the advertisement is a public service, whether the advertisement relates to such things as sports, leisure, travel, entertainment, apparel, food, medical products/services, home electronics, automotive, career, etc. The tag 10 may include a description of the target audience to whom the advertisement 12 should be directed. The tag 10 may include some type of rating (e.g., is the advertisement more suitable for mature audiences, family audiences, etc.).

The tag 10 may indicate the duration of the advertisement (e.g., the time length of the advertisement in seconds and/or minutes). The tag 10 may also indicate the number of times that the advertisement 12 is to be played within, for example, a time period. This may include the total number of times in a particular time period and/or an overall total number of times. Advertisement insertion rules may be implemented to covers various time/duration issues. For example, an advertisement may be time sensitive and may be assigned an expiration date and/or a duration time period. An advertisement may be assigned a maximum number of times that it can be inserted into content slots over a period of time (e.g., an advertisement may be limited to two slots in a week, etc.). Advertisement insertion rules may regulate the time of placement of an advertisement in a slot (e.g., daytime, evening, weekend, etc.).

The tag 10 may indicate the preferred media or broadcaster (e.g., preferred TV shows or networks, etc.). The tag 10 may indicate device or media viewing requirements (e.g., screen size, stereo, interactive, etc.). The tag 10 may indicate slot timing within the content (e.g., none, beginning only, end only, dramatic moment or scene change, etc.)

The tag 10 may indicate the style of the advertisement 12 (e.g., whether the advertisement 12 is whimsical and lighthearted, whether the advertisement 12 relates to a serious topic, etc.). The tag 10 may also indicate whether the advertisement 12 is interactive (i.e., can be interacted with by a viewer).

Referring to FIG. 3, a decision engine 16 that is configured to select advertisements for insertion into advertising slots of broadcast content, such as television program slots, is illustrated. The decision engine 16 is configured to select advertisements 12 by analyzing tags 10 attached to advertisements 12 and by applying various rules or criteria associated with the broadcast content, viewers of the broadcast content, and/or the environment. Exemplary broadcast criteria 18 includes information about the broadcast content that an advertisement is to be selected for. In the context of a television program, this may include, but is not limited to, whether the television program is broadcast in prime time or non-prime time, whether the television program is directed to a mature audience, a family audience, etc. Other decision engine insertion criteria include, but are not limited to, the time of day of advertisement insertion, the urgency of the advertisement, other audience characteristics (if known), whether the advertisement format matches with media being played (comedy based advertisements placed within entertainment content, serious advertisements placed within dramatic content, travel advertisements, fitness advertisements, apparel advertisements and entertainment advertisements placed within sports content, etc.). Decision engine insertion criteria may include viewing location or device information (e.g., family room, vs. portable player, vs. kitchen; size and/or style of TV (e.g., big screen LCD vs. 7″ portable player), etc.).

Other exemplary criteria utilized by the decision engine 16 may include viewer criteria 20. Viewer criteria 20 may include, but is not limited to, personal viewer preferences, other viewer information. Viewer preferences and information may be for a group of viewers and/or may be for individual viewers where available. Exemplary personal preferences and information includes, but is not limited to, information such as a viewer's likes and dislikes (e.g., the viewer is a sports fan, the viewer does not like opera, etc.), the viewer's habits (e.g., the viewer drinks beer, smokes cigars, etc.), age, sex, marital status, political affiliation, occupation, nationality, ethnicity, culture, location, residence, etc. Viewer criteria 20 may also include advertising preferences (e.g., the viewer likes funny advertisements, does not like truck advertisements, etc.).

Other exemplary criteria utilized by the decision engine 16 may include environment criteria 22. Environment criteria 22 may include, but is not limited to, time of day content is broadcast to viewers, what type of viewers are most likely to be watching (e.g., children, family, older people, etc.).

In essence, the decision engine 16 serves as a gatekeeper and selects advertisements 12 to be inserted within television program advertising slots by analyzing information within the tags of advertisements and comparing this with various criteria (e.g., broadcast criteria, viewer criteria and environment criteria).

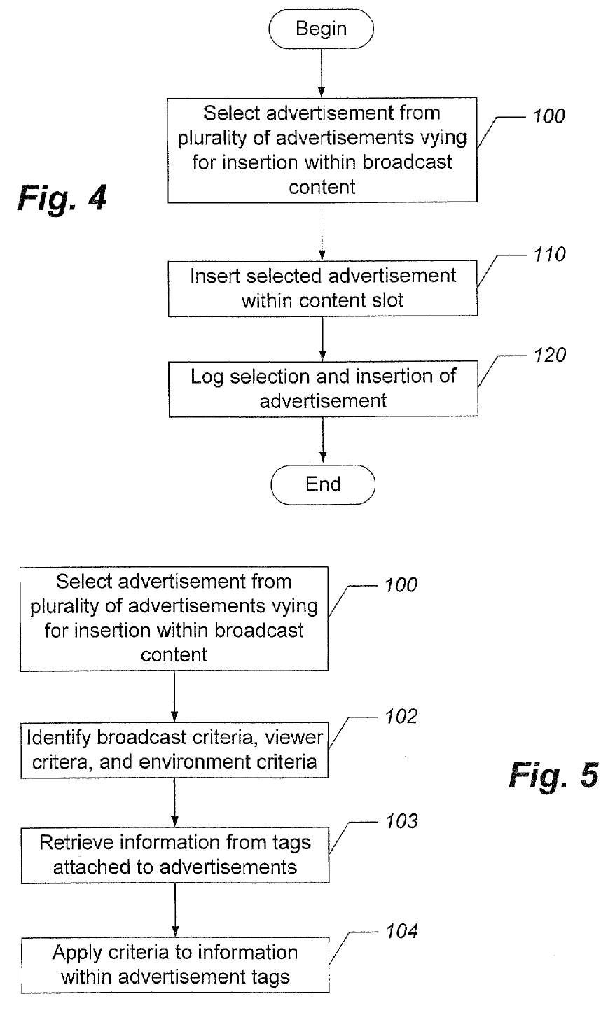

Exemplary operations for selecting advertisements for insertion within advertisement slots of broadcast content, such as television programming, according to some embodiments of the present invention, will now be described with reference to FIGS. 4-5. A plurality of advertisements 12 are vying for insertion within advertising slots within broadcast content, such as a television program. A decision engine 16 selects an advertisement from the plurality of advertisements (Block 100), inserts the selected advertisement within one or more advertising slots of the broadcast content (Block 110), and logs the selection and insertion of the advertisement within one or more advertising slots of the broadcast content (Block 120). Selection of an advertisement (Block 100) includes identifying broadcast criteria for content, viewers, and/or environment (Block 102), as described above, retrieving information from tags attached to advertisements as described above (Block 103), and applying criteria to information retrieved from the advertisement tags (Block 104).

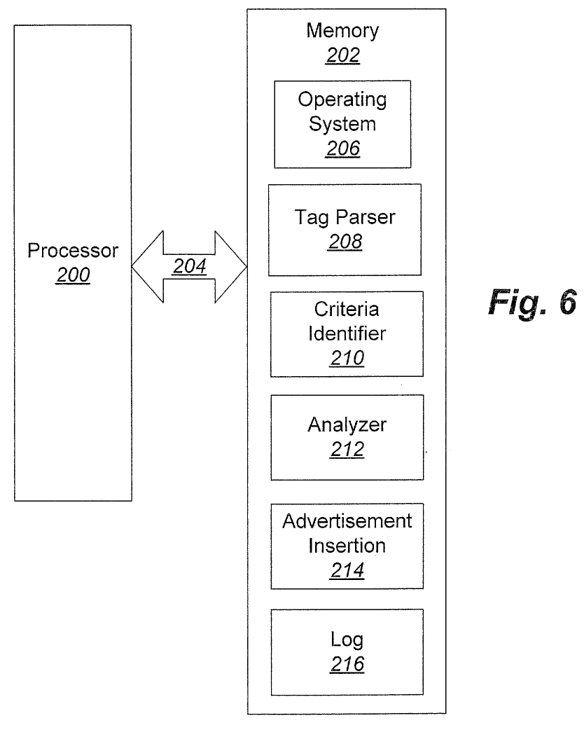

FIG. 6 illustrates a processor 200 and a memory 202 hosted by a device that serves the function of a decision engine 16 and that may be used in embodiments of methods, systems, and computer program products for selecting advertisements for insertion into advertising slots in broadcast content, such as television programming, according to some embodiments of the present invention. The processor 200 communicates with the memory 202 via an address/data bus 204. The processor 200 may be, for example, a commercially available or custom microprocessor. The memory 202 is representative of the overall hierarchy of memory devices containing the software and data used to execute operations for selecting advertisements for insertion within content as described herein, in accordance with some embodiments of the present invention. The memory 202 may include, but is not limited to, the following types of devices: cache, ROM, PROM, EPROM, EEPROM, flash, SRAM, and DRAM.

As shown in FIG. 6, the memory 202 may hold various categories of software and data: an operating system 206, tag parser 208, criteria identifier 210, analyzer 212, advertisement insertion 214, and logging application 216. The operating system 206 controls operations of the device that serves the function of the decision engine 16. In particular, the operating system 206 may manage a device's resources and may coordinate execution of various programs (e.g., the tag parser, criteria identifier, analyzer, advertisement insertion, and logging application, etc.) by the processor 200.

The tag parser 208 comprises logic for parsing information stored within each tag of a respective advertisement so that the information can be analyzed and compared with the identified criteria. The criteria identifier 210 comprises logic for identifying criteria associated with broadcast content, viewer criteria, and/or environment criteria. The analyzer 212 comprises logic for applying identified criteria to information retrieved from the tags in order to select an advertisement. For example, the following criteria may be identified relative to a particular television program: the broadcast content is prime time content that is targeted to mature audiences, viewers of the content tend to be over fifty years old and predominantly female, and the prime time slot makes viewing by various members of a family a possibility (i.e., the time slot makes it possible that children may be viewing). Based upon the identified criteria, the analyzer 212 analyzes information parsed from the tags of available advertisements to select an appropriate advertisement. For example, an advertisement may be selected that includes tag information that indicates that the advertisement is suitable for a generally older female viewing audience and that is also suitable for all members of a family if they happen to be viewing at the time.

The advertisement insertion application 214 comprises logic for inserting a selected advertisement within an advertisement slot, such as a television program advertisement slot. Moreover, the advertisement insertion application 214 may be configured to insert a selected advertisement in multiple advertising slots of a television program. Advertisement insertion during a particular television program may be configured to spread the advertisement out at certain intervals, or directly place it at a particular point, for example, as follows: at the beginning, at the end, in the middle, at a major scene change only, and/or combinations of these.

The logging application 216 comprises logic for recording information about what advertisements the decision engine 16 selected, in what broadcast content the selected advertisements were inserted. In addition, the logging application 216 is configured to record information about viewers from the various criteria (content, viewer and environment).

FIGS. 1-6 illustrate the architecture, functionality, and operations of some embodiments of methods, systems, and computer program products for selecting advertisements and inserting them within advertisement slots in broadcast content. In this regard, each block represents a module, segment, or portion of code, which comprises one or more executable instructions for implementing the specified logical function(s). It should also be noted that in other implementations, the function(s) noted in the blocks may occur out of the order noted in FIGS. 4-5. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

That which is claimed:

1. A method of inserting an advertisement into an advertising slot within content broadcast to viewers, comprising:
identifying broadcast criteria for the content and viewer criteria, wherein broadcast criteria comprises information about the content and wherein viewer criteria comprises information about viewers to whom the content is targeted;
retrieving information from a plurality of tags attached to a respective plurality of advertisements available for insertion into the advertising slot, wherein each tag includes information about a respective advertisement;
selecting an advertisement having tag information that is compatible with identified broadcast criteria and viewer criteria; and
inserting the selected advertisement into the advertising slot.

2. The method of claim 1, further comprising recording the identified broadcast criteria, viewer criteria, and tag information for the selected advertisement.

3. The method of claim 1, wherein the broadcast content is a television program.

4. The method of claim 1, wherein the broadcast content is a radio program.

5. The method of claim 1, wherein the broadcast content is content broadcast via a computer network.

6. The method of claim 1, wherein broadcast criteria includes time of day information that content is to be broadcast to viewers and/or information about types of viewers to whom the broadcast content is targeted.

7. The method of claim 1, wherein viewer criteria includes viewer preference information regarding broadcast content, viewer preference information regarding advertisements, viewer personal characteristics, and/or viewer demographic information.

8. The method of claim 1, wherein tag information includes information regarding advertisement type and category, targeted viewers, advertisement rating, advertisement duration and repetition, advertisement style, and/or advertisement interactivity.

9. The method of claim 1, wherein retrieving information from tags attached to a respective plurality of advertisements comprises parsing text files stored within the tags.

10. A system that inserts advertisements into advertising slots within content broadcast to viewers, comprising:
a plurality of stored advertisements, wherein each advertisement has a respective tag attached thereto, and wherein each tag includes information about a respective advertisement; and
a decision engine that comprises:
means for identifying broadcast criteria for broadcast content and viewer criteria, wherein the broadcast criteria comprises information about the content and wherein viewer criteria comprises information about viewers to whom the content is targeted;
means for retrieving information from the tags attached to the advertisements;
means for selecting an advertisement having tag information that is compatible with identified broadcast criteria and viewer criteria; and
means for inserting the selected advertisement into an advertising slot within the broadcast content.

11. The system of claim 10, wherein the decision engine further comprises means for recording the identified broadcast criteria, viewer criteria, and tag information for the selected advertisement.

12. The system of claim 10, wherein the broadcast content is a television program.

13. The system of claim 10, wherein the broadcast content is a radio program.

14. The system of claim 10, wherein the broadcast content is content broadcast via a computer network.

15. The system of claim 10, wherein broadcast criteria includes time of day information that content is to be broadcast to viewers and/or information about types of viewers to whom the broadcast content is targeted.

16. The system of claim 10, wherein viewer criteria includes viewer preference information regarding broadcast content, viewer preference information regarding advertisements, viewer personal characteristics, and/or viewer demographic information.

17. The system of claim 10, wherein tag information includes information regarding advertisement type and category, targeted viewers, advertisement rating, advertisement duration and repetition, advertisement style, and/or advertisement interactivity.

18. The system of claim 10, wherein the means for retrieving information from tags attached to the advertisements comprises means for parsing text files stored within the tags.

19. A computer program product for inserting an advertisement into an advertising slot within content broadcast to viewers, comprising:
a computer readable storage medium having computer readable program code embodied therein, the computer readable program code being configured to carry out the method of claim 1.
